(19) United States
(12) Patent Application Publication
(10) Pub. No.: US 2005/0123642 A1
(43) Pub. Date: Jun. 9, 2005

(54) Feed pellets and a method for manufacture of said pellets

(75) Inventors: Niels Harthoj Hjermitslev, Jelling (DK); Torben Duedal Jensen, Brande (DK); Terje Rimestad, Bryne (DK)

Correspondence Address: WENDEROTH, LIND & PONACK, L.L.P., 2033 K STREET N. W., SUITE 800, WASHINGTON, DC, 20006-1021, US

(73) Assignee: Biomar Group, Brande (DK)

(21) Appl. No.: 10/508,486

(22) PCT Filed: Mar. 22, 2002
(86) PCT No.: PCT/NO02/00121

(51) Int. Cl. A01K 1/00

(52) U.S. Cl. 426/2

(57) ABSTRACT

The present invention relates to a method for production of feed pellets comprising grinding of the raw materials prior to extrusion, and such pellets comprising 0-20 weight % carbohydrates, 30-45 weight % protein, 35-52 weight % lipid, 2.5-10 weight % water and the balance being water. The raw materials comprising 0-26 weight % carbohydrates, 30-70 weight % protein, 3-30 weight % lipid and 12-30 weight % water are ground to an average particle size of less than 0.25 mm. The pellets are a homogenous mixture of raw materials comprising 0-26 weight % carbohydrates, 30-70 weight % protein, 3-30 weight % lipid and 12-30 weight % water having an average particle size of less than 0.25 mm and having been extruded and coated with lipid constituting at least 75 weight % of the total lipid content of the pellets.

The present invention relates to feed pellets and a method for manufacture of said pellets having a high content of fat, comprising grinding of the raw material such as carbohydrates, protein, fat etc., extrusion of said raw materials, cuffing up the extruded mass, drying the pellets and subsequent coating with a lipid.

There is an increasing demand for high energy feeds having fat content of 30-50 weight %, however, it has proved to be difficult to obtain products with the desired properties by performing the production using conventional methods. The main problem is to make pellets having the desired high content of fat and where the pellets retain the fat during handling and storage. Oil leakage causes several problems in addition to the fact that the pellets when used do not contain the specified fat content. Another problem is the crushing strength of such pellets. the density of the pellets shall also be sufficiently high for securing that the pellets sink into the water occupied by the fish receiving the feed.

Manufacture of feed pellets by extrusion is generally known in the art. Thus WO98/161121 describes a method for making sinking aquatic feed pellets containing 10-40 weight % fat. A high protein starting material is initially pre-conditioned and passed through an extruder. In the extruder barrel a zone of reduced pressure is created upstream of the die for densifying the final extrudate. Fat may be added to the starting mixture at any desired point in the process, and/or added as a surface coating of the dried extrudate. This method is primarily applied for obtaining the desired density of the feed pellets and thereby secure that they will sink during feeding of the fish.

One way of increasing the absorption of fat into the pellets is to perform the surface coating under vacuum. Such a method is described in U.S. Pat. No. 4,971,820. One way of obtaining feed pellets having relatively high content of fat is described in Norwegian Patent No. 301,310. According to this patent a substantial part of the fat is incorporated in the extruded pellets and only minor parts of the fat is added as a surface coating. The main feature is to add substantial amounts of starch to the feed raw material before extrusion. At least 20 weight % and preferably about 30 weight % of the pellet is starch. Maize or wheat are the preferred sources for starch. The starch source shall have a defined size, preferably 50%, and preferably 75% of the starch source shall pass through a Tyler no. 50 mesh sieve. The ratio protein source:starch source should be 3:1 to 1:3. The feed nuggets comprise 20 weight % or more starch, 15% or more added fat and less than 15 weight % water.

It is further known from the patent application WO 98/49904 a method for reducing the leakage of fat from pellets having a high fat content. The method comprises extruding a mixture of basic components for forming a matrix of fish feed pellets together with an additive which is solid under ambient temperature, into porous pellets. The additive is a lipid or a fatty acid.

The main object of the invention was to arrive at an improved method involving a minimum alteration of the basic process and raw materials applied for producing feed pellets having a high fat content.

Another object was to arrive at feed pellets having a high fat content and a low leakage of fat during handling and storage, and having the required crushing strength.

In their evaluation of known methods for improving the production of feed pellets the inventors found that said methods involved complicating alterations which could result in undesired properties of the pellets, such as reduced crushing strength and reduced contents of desired feed components.

Thorough studies of the basic process revealed that some of the process steps could be performed in a different way without substantially changing the process. The question was then what effect this would give on the final product. The inventors then looked at the preconditioning of the raw materials prior to the extrusion step, and it was then decided to study the possible effects of the particle size on the final product. In spite of the fact that smaller particles could result in denser pellets with lower ability to absorb oil, experiments were started using raw materials having substantially lower particle size than that applied in conventional processes. It was then surprisingly found that micronization of the raw material to such a degree that the major part of the raw materials had an average particle size lower than 0.25 mm resulted in extruded pellets which during the coating step could absorb large amounts of oil and also retain high amounts of fat during handling and storage of the pellets. The lower limit for the particle size will be a practical one depending on grinding equipment and grinding costs. Even the crushing strength of the pellets was improved, and they had a most homogenous structure. The raw materials applicable for treatment before the extrusion step according to the present invention were found to be within the following ranges in weight %:

| | |
|---|---|
| Protein: | 30-70 |
| Carbohydrates: | 0-26 |
| Lipid: | 3-30 |
| Water: | 12-30 |

The term “average particle size” used in the present application means that 50 weight % of the particles are within the stated particle size.

Subsequent to the extrusion step, the particles were coated as known per se with fish oil. Other lipids such as fat, vegetable oil etc. could, however, be applied.

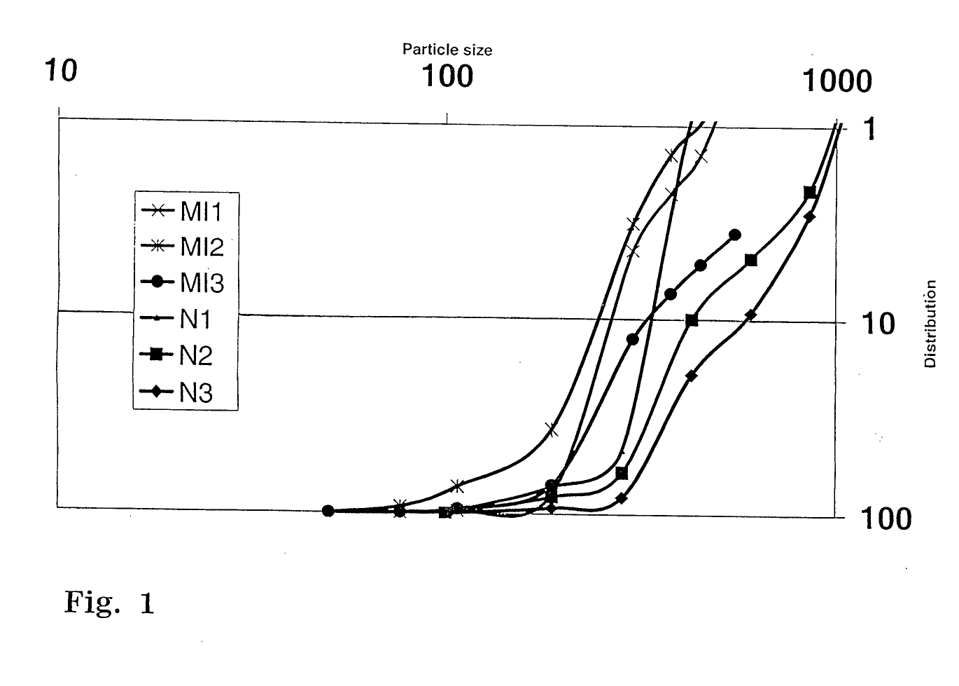

The positive effects attained by the invention can not at present be fully explained. However, it seems that the unusually low particle size is the main contributor. Further, it seems that steep curves for the particle size distribution (FIG. 1) will be advantageous, i.e. a narrow particle size distribution.

The invention is further envisaged and explained in the following example.

The scope and special features of the invention are as defined in the attached claims.

The main feature of the process implies that the raw materials comprising 0-26 weight % carbohydrates, 30-70 weight % protein, 3-30 weight % lipid and 12-30 weight % water are ground to an average particle size of less than 0.25 mm.

Preferably there are applied raw materials where more than 80% of the particles have a particle size of 0.15-0.230.

Another preferred feature comprises that at least 75% of the lipid in the final pellets are incorporated during the coating step.

The main feature of the product according to the invention is that the pellets are a homogenous mixture of raw materials comprising 0-26 weight % carbohydrates, 30-70 weight % protein, 3-30 weight % lipid and 12-30 weight % water having an average particle size of less than 0.25 mm and having been coated with lipid constituting at least 75 weight % of the total lipid content of the pellets.

FIG. 1 shows a logarithmic graph of particle size versus particle size distribution for the raw materials used during the experiments.

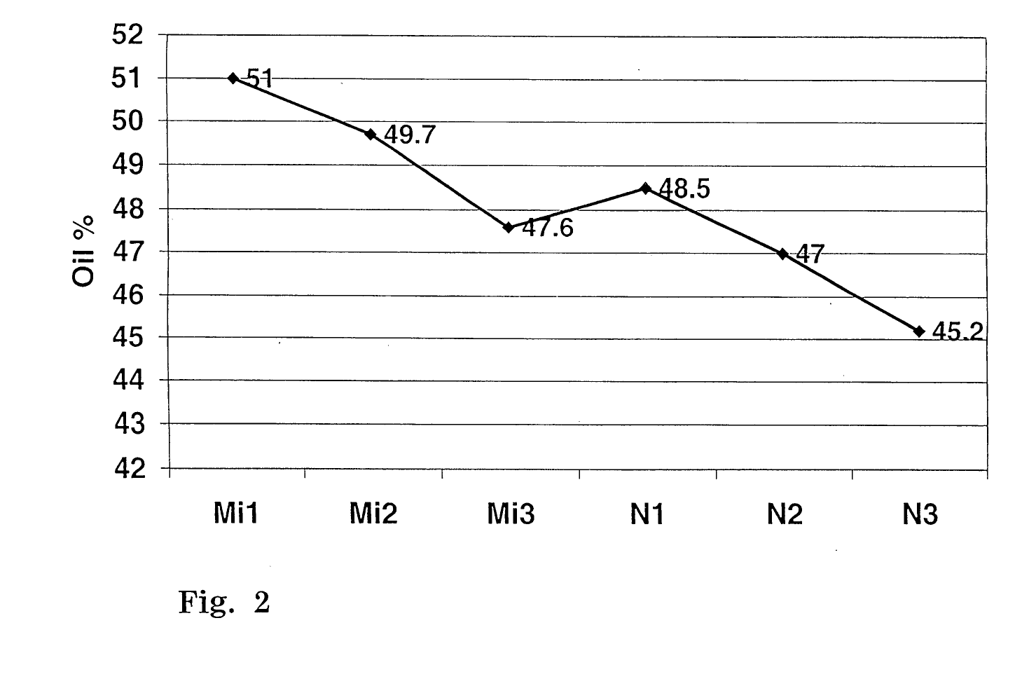

FIG. 2 shows oil absorption of pellets made from raw materials having varying particle size.

FIGS. 1 and 2 show the results from two different runs. The results for N1-3 relate to conventional raw materials ground in a Hammer Mill, and the results for Mi1-3 relate to raw materials according to the invention, and they were ground in a Micronizer Mill. In the curve shown in FIG. 2 the line between Mi3 and N1 is therefore a theoretical one.

### EXAMPLE 1

This example shows the effect of preconditioning the raw materials by grinding/micronization to particle sizes of 0.105-1.5 mm.

The process was performed by first grinding the raw materials to desired particle size before the raw materials were sieved for removal of large particles, and fed to an extruder, which could be operated both at pressures above and below ambient pressure. The extrudate was cut into pellets which were dried and subjected to coating with a lipid. The coating process was performed at a temperature of about 60° C. and a pressure of 100-500 m bar.

The various raw materials applied during the experiments are coded N1-3 according to conventional processes and M1-3 according to the invention. The raw materials N1-3 were ground in a hammer mill and sieved to the respective particle sizes 0.5, 0.75 and 1.5 mm. The raw materials M1-3 were micronized in an Alpine No. 166 micronizer ground to the respective particle sizes. These raw materials had the following composition in weight %:

| | |
|---|---|
| Fish meal (LT meal produced by BioMar): | 46.145 |
| Soya protein concentrate 66.: | 12.300 |
| Descaled wheat: | 12.488 |
| Wheat gluten: | 6.089 |
| Mineral and vitamin premix: | 1.05 |
| Water: | 11.938 |

Tables 1 and 2 show the particle size distribution for the raw materials, known ones and according to the invention, respectively, used during the experiments, and this is also shown in FIG. 1.

TABLE 1

| A | >1000 | >710 | >500 | >355 | >212 | >125 | <125 |
|---|---|---|---|---|---|---|---|
| N1 (0.5 mm) | 0.1 | 0.2 | 0.3 | 0.9 | 46.8 | 71.9 | 100.3 |
| N2 (0.75 mm) | 0.5 | 2.1 | 4.8 | 9.9 | 60.5 | 81.0 | 100.0 |
| N3 (01.5 mm) | 0.6 | 2.8 | 9.2 | 19.2 | 81.3 | 93.1 | 100.2 |

TABLE 2

| B | >500 | >400 | >355 | >250 | >125 | >90 | >63 | <63 |
|---|---|---|---|---|---|---|---|---|
| Mi1 (0.155 | 0.5 | 1.4 | 2.2 | 4.4 | 79.0 | 97.0 | 99.7 | 100.2 |
| mm) | | | | | | | | |
| Mi2 (0.105 | 0.5 | 1.0 | 1.4 | 3.2 | 36.8 | 72.3 | 92.4 | 100.2 |
| mm) | | | | | | | | |
| Mi3 (0.151 | 3.5 | 5.2 | 7.3 | 12.6 | 70.6 | 94.5 | 99.1 | 100.0 |
| mm) | | | | | | | | |

The particle sizes for the samples A (N1-3) and B (Mi1-3) in Tables 1 and 2 are the average particle sizes, while the tables show the particle size distribution within the ranges stated in the first line of the tables.

TABLE 3

| | Oil | Water |
|---|---|---|
| Sample | weight % | weight % |
| Mi1 | 51 | 4.8 |
| Mi2 | 49.7 | 4.7 |
| Mi3 | 47.6 | 4.8 |
| N1 | 48.5 | 4.6 |
| N2 | 47 | 4.6 |
| N3 | 45.2 | 4.2 |

Table 3 shows oil and water content of the pellets after the coating step and corresponds to FIG. 2, wherefrom it can be seen that the samples according to the invention have higher oil content than the samples of known origin.

From the above figures and example it can be seen that the inventors have succeeded in arriving at an improved process resulting in a new product being most homogeneous and having high oil content without substantially altering the basic process for producing feed pellets.

1-4. (canceled)

5. A method for manufacture of feed pellets having a high content of fat, comprising grinding of the raw materials prior to being fed to an extruder and cut into pellets which are dried and subjected to coating with lipid, characterized in that
the raw materials comprising 0-26 weight % carbohydrates, 30-70 weight % protein, 3-30 weight % lipid and 12-30 weight % water are ground to an average particle size of less than 0.25 mm, and where the substantial amount of lipid in the final pellets is added by said coating.

6. A method according to claim 5, characterized in that
there are applied raw materials where more than 80% of the particles have a particle size of 0.15-0.230.

7. A method according to claim 5, characterized in that
at least 75% of the lipid in the final pellets are incorporated during the coating step.

8. Feed pellets comprising 0-20 weight % carbohydrates, 30-45 weight % protein, 35-52 weight % lipid, 2.5-10 weight % water and the balance being ash, characterized in that
the pellets are a homogenous mixture of raw materials comprising 0-26 weight % carbohydrates, 30-70 weight % protein, 3-30 weight % lipid and 12-30 weight % water having an average particle size of less than 0.25 mm and having been extruded and coated with lipid, where the substantial amount of lipid in the final pellets is added by said coating.
